(19) United States
(12) Patent Application Publication
(10) Pub. No.: US 2022/0325965 A1
(43) Pub. Date: Oct. 13, 2022

(54) MASS TRANSFER DEVICE CLEANING SYSTEM AND SPACER

(71) Applicant: C2K INNOVATIONS LLC, Glenmoore, PA (US)

(72) Inventors: Christopher BOWMAN, Glenmoore, PA (US); Frank M. KULICK, III, Glenmoore, PA (US)

(21) Appl. No.: 17/696,199

(22) Filed: Mar. 16, 2022

Related U.S. Application Data
(60) Provisional application No. 63/173,757, filed on Apr. 12, 2021.

(51) Int. Cl. F28G 9/00; F28G 15/02

(52) U.S. Cl. CPC F28G 9/00; F28G 15/02

(57) ABSTRACT

A cleaning system for a mass transfer or cooling tower device having an enclosure, an air inlet and an air outlet in the enclosure, and first and second fill packs in the enclosure positioned between the air inlet and the air outlet. The first and second fill packs have peripheries that are positioned proximate to internal walls of the enclosure. The cleaning system includes an inlet connection mounted to the enclosure and a delivery piping system connected to the inlet connection. The delivery piping system includes a cleaning portion positioned within the enclosure between the first and second fill packs. The cleaning portion includes nozzles configured to direct a cleaning fluid onto the first and second fill packs.

### CROSS-REFERENCE TO RELATED APPLICATIONS

The present application claims the benefit of U.S. Provisional Patent Application Nos. 63/173,757, filed Apr. 12, 2021 and titled, “Mass Transfer Device Cleaning System and Spacer,” the entire contents of which is incorporated herein by reference in its entirety.

### BACKGROUND OF THE INVENTION

Mass transfer devices are a category of equipment where mass is either transferred into or out of a solution, typically water or aqueous based solution, in the presence of a gas stream, typically air. Evaporative heat exchangers utilize the heat of vaporization of a fluid, in most cases water, for increased heat transfer or heat rejection over sensible heat transfer methods. Equipment like Cooling towers, fluid coolers, evaporative condensers and hybrid coolers are a few examples of these evaporative technologies. Evaporative heat exchangers are mass transfer devices used to remove waste heat from many industrial and commercial processes. As water circulates through the open loop and is distributed over the heat transfer surfaces, water vapor is removed by outside air, induced or forced, through the evaporative heat exchanger using a fan or natural convective forces. Closed circuit fluid coolers and hybrid coolers, for example, are heat exchangers used similarly that can be operated in dry and wet modes of operation. In the dry mode, air passes through the heat exchanger over a coil or tubing removing sensible heat. The dry bulb temperature of the air increases and the temperature is reduced in fluid within the coil. In wet operation, the process relies on mass transfer to remove heat energy from the water and lower its temperature and, as such, the concentration of ionic species increases as water evaporates. Makeup water is added to maintain the appropriate water volume for the open loop circulation and to maintain water chemistry parameters. Salts like Calcium carbonate are of a concern as an increase in salt and mineral concentration causes precipitation on surfaces within the open loop process, or more commonly called scale. In addition to scale, the open loop water circulated achieves oxygen saturation conditions due to contact with oxygen present in the air induced or forced through the fill. This oxygen rich water is at an elevated temperature and supports biological growth which leads to biofouling of the fill media and overall loss of heat transfer capabilities of the evaporative heat exchangers.

Wet scrubbers are pollution control devices used to remove particulate and/or chemical pollutants from exhaust gases of combustion. Similar technology, terminology or processes include contactors, direct air capture (DAC), CO₂ Capture equipment, direct air contact equipment, or air stripping equipment. Scrubbers are also used in industrial processes to remove water-soluble toxic and/or corrosive gases from process streams and heat recovery from hot gases by flue-gas condensation.

The scaling and biofouling that exists in a cooling tower has several effects on cooling tower performance. First and most obviously, the scaling and biological growth on the surface of the cooling tower fill increases the air-side pressure drop reducing the air flow rate. Since the air exiting the cooling tower process is saturated with water vapor, this results in a much-reduced effective heat rejection capacity of the cooling tower. In addition, the occlusion of the fill due to scale and biofilm growth on the fill surfaces reduces the size of the openings which results in a lower effective surface area of the fill for mass transfer. Scaling and biofilm growth are affected by both water flow and airflow. Increased water flow through the fill tends to minimize biofilm growth due to mechanical scouring on the fill surfaces and tends to minimize scaling from concentration gradients during mass transfer. Increased airflow tends to indicate low flushing conditions by the water flow and promotes evaporation and subsequent scaling.

Scaling in a fluid cooler is more significant as heat is transferred to the open loop fluid directly through conduction. As water evaporates from the open loop water, the salt concentration increases and scale formation on the coil surface within the fluid cooler occurs. The scale formed on the tubes of the exchanger decreases the effective heat transfer coefficient reducing the heat transfer capacity of the cooler. Since conduction is the mechanism for heat transfer to the open loop water, thermal performance suffers greatly over the performance of a cooling tower with similar scale buildup.

Scrubbers also suffer from scale formation at fluid gas interfaces where “dry” inlet air contacts water and mass transfer occurs. In addition, particulate plating prevails at these interfaces when particulate scrubbing occurs either independently or in combination with the removal or absorption of chemical pollutants, targeted chemistry, or heat transfer.

The mechanical impact of the water on the top layer of fill distributed through the nozzles in a cooling tower significantly reduces the biofilm thickness at the upper fill level within the tower. Additionally, the saturated condition of the air as it leaves the cooling tower fill limits the evaporation rate as the air exits the fill vertically minimizing precipitation of salts and minerals and therefore scale formation as the evaporation rate and resulting salt concentration varies vertically on the surface of the fill.

In counterflow cooling towers and some hybrid fluid coolers, water travels downwardly via gravity through multiple layers of fill and air flows upwardly in a counter flow arrangement. The fill is usually cross stacked, that is the sheets of underlying layers of fill packs or modules oppose each other by about ninety degrees (90°), to provide structural support and transfer of load vertically from one pack to the next as well as to help distribute air and water in varying directions from layer to layer. Commonly termed the pack-to-pack interface, or interface, the upper edge of the sheets in the bottom pack and the lower edge of the sheets in the upper pack form a crossing condition at the edge of the sheets which increases biofouling due to biological growth bridging from pack to pack from this increased edge density and interface points that slow the velocity of water and allow for deposits to adhere and accumulate. The increased biological growth reduces both air flow and water flow due to the occlusion of the openings as the water and air transfer from pack to pack. It is generally at this point that increased scaling and biological growth occur in the counterflow cooling tower as you move toward the bottom of the fill from a top of the tower. Similarly, this phenomenon is noticed at the sheet contact locations within the fill pack where water velocity is reduced and biological growth and salts can more readily adhere, precipitate, and ultimately accumulate.

In crossflow cooling towers or some hybrid fluid coolers, the water flows downwardly via gravity through the crossflow style fill and air flows horizontally in a crossflow arrangement. The fill is typically supported by structural members at each layer of fill or hung from support bars. This arrangement can provide a space or gap between successive layers of fill where water flows from the upper fill layer directly into the lower layer(s). Crossflow fill packs are generally taller than counterflow fill packs lending to a difference in the location of biofouling and scale formation based on water and air flow conditions. Scale forms near the air inlet at the integrally formed louvers and biofouling occurs more internal to the crossflow packs closer to the integrally formed drift eliminators or the air leaving side of the fill. The direct impact of the water from the fixed distribution system above the fill maintains lower biofilm growth than within the bulk of the fill packs where the water has lower impact energy and velocity.

In a fluid cooler, scale forms more predominantly in areas exposed to higher air flow and lower water flow. In general, biofouling is not a significant concern as the coil of the fluid cooler is typically exposed to sunlight; however, algae may form in the presence of sunlight if the right conditions exist.

Increasing regulations have been introduced in recent years to limit the effects of many different bacteria, including, but not limited to Legionella pneumophila on cooling tower operation. For instance, requirements for periodic cleaning and disinfection of the cooling tower loop have been enacted that increases the recurring maintenance costs of the tower as well as imposing restrictions for the operation of these critical devices used to maintain comfortable environmental conditions and vital equipment related to the health and welfare of the building occupants.

The typical maintenance action to counteract the reduced cooling tower thermal performance and potential for harmful bacterial growth is to clean the fill with a biocide and scale remover in the bulk open loop water, manually clean the fill externally with a system designed to treat the fill surfaces that can be reach from outside the tower with the fill in place or replace the fill. Removal and cleaning of each fill module is also an option but is costly in time and labor and can potentially cause damage to the fill from excessive handling. The global treatment of the fill through the addition of chemicals to the open loop water can be expensive due to the large volumes of water required to treat at the appropriate chemical concentration and may require the tower to be taken out of service. The nozzles installed for loop recirculation are large and sized appropriately for the recirculation flow rate to provide adequate distribution and wetting of the cooling tower fill surfaces, not for maintenance and cleaning of the system. Additionally, field erected and larger towers are generally constructed with common sumps across multiple cells where redundancy is required. The individual cells can be taken out of service for manual cleaning; however, the sump is common and, in many cases, cannot be isolated for this type of maintenance. The global treatment method using existing distribution piping and nozzles increases the amount of chemical required to clean the fill in-situ and generates a large amount of waste. Manual systems utilized for cleaning coils in an HVAC system, such as the apparatus depicted in U.S. Pat. No. 7,841,351 B1, clean the fill on its surface and a very limited internal portions; however, the penetration of chemicals into the fill is limited to the effects of gravity as well as the inherent structure of the fill sheets to limit full penetration or line of sight. In the specific case of a fluid cooler, cleaning systems exist for the internal surfaces of the fluid cooler tubing such as the descaling system described in U.S. Pat. No. 8,926,765 B1, but this system does not descale or clean the external open loop surfaces of the system exposed to air flow. Moreover, systems designed to chemically clean the outside of coils of an HVAC system that are exposed to dry air, such as U.S. Pat. No. 9,266,152 are portable in nature and rely on manual manipulation of a wand by a technician to apply cleaning flow and/or chemicals onto the external surfaces of the coils. This system is manual and labor intensive. For an air cooled heat exchanger (“ACHE”), U.S. Pat. No. 8,974,607 shows an installed cleaning apparatus of heat exchange tubes for a coil containing finned tubes with a spray mat placed between layers of tubes capable of being moved in and out of position that may also be used in a wet cooling operation.

It is desirable to reduce the cost of cleaning and disinfecting cooling tower components and improve the resultant tower performance back to near that of the newly installed fill. More specifically, it is desirable to effect one or more of the following changes depending upon the current cleaning method selected; reduce the amount of chemicals required to clean, clean one cell at a time, target areas in the tower where fouling is known to occur, access previously inaccessible locations with cleaning chemicals, reduce the labor cost of cleaning, reduce the amount of chemicals used, and reduce the amount of waste generated. The preferred invention addresses the distribution of biocides and scale remover and any chemical deemed necessary to treat fill media to locations within the cooling tower where these fouling conditions persist, specifically, but not limited to, within the fill below the top layer. Additionally, the preferred invention reduces the interface fouling effects of the current method of fill placement.

### BRIEF SUMMARY OF THE INVENTION

Briefly stated, the preferred invention is directed to a system for distributing cleaning chemicals to desired locations within an evaporative heat exchanger such as a cooling tower, evaporative condenser, hybrid cooler or fluid cooler. The system includes a connection, piping, nozzles, and in some cases, grating or spacers. The connection serves to receive chemicals from a pump discharge providing flow of cleaning chemicals to piping of the system. The piping transmits cleaning chemical flow to nozzles and orifices strategically placed within the evaporative heat exchanger unit. The nozzles release or spray the chemicals into the fluid cooler coil or cooling tower fill for direct placement on fouled or likely to be fouled heat transfer surfaces. The nozzles are sized to distribute the cleaning chemicals at a flow rate appropriate for the size and configuration of the pump and amount of chemical used, preferably separate from the open loop water distribution system.

In another aspect of the preferred invention, the piping is positioned by a grating or spacer that also provides structural support for layers of fill and a void space for the distribution of cleaning chemicals within the fill. The grating is placed on top of a layer of fill. The piping is placed in an arrangement to distribute the chemicals in a series or parallel configuration.

The grating or spacer is designed with an open arrangement, that is, the pattern of vertical supports is such that the pattern allows for a reduced number of contact points with the edge of the fill above and below the grating or spacer and allows for communication across flute openings within its height limitation.

For a series flow configuration, the piping is preferably placed in a serpentine pattern to provide coverage of the plan view of the cooling tower fill. For a parallel flow configuration, the piping preferably comprises a header connected to laterals. Typically, holes or slots are placed in the piping or tubing to define nozzles for release of chemicals to the appropriate locations along its length or dedicated nozzles are plumbed down the length of piping or tubing to define the distribution system.

Alternatively, a connection, piping, and a single nozzle may be used to inject cleaning chemicals above the mass transfer media, above a coil in the spray zone, or prior to mass transfer media in the gas stream to achieve the intent of this preferred invention, which is described in greater detail herein.

Alternatively, rigid PVC piping may be used as both the chemical cleaning distribution system as well as the vertical spacer between fill or coils. In this preferred example for instance, the fill would be placed directly on the rigid PVC piping used to distribute cleaning chemicals to locations within the fill volume.

A dedicated and specific distribution system is desired to inject cleaning chemicals at locations within the tower fill more precisely to where fouling is occurring. The preferred invention can be simple tubing or pipe placed between layers of fill or installed within aligned holes in the sheets and essentially through the packs. The delivery system can be as simple as holes of an appropriate size drilled through one side or multiple sides of the tubing or pipe but is designed to deliver the desired treatment chemicals thoroughly within the layers of fill packs or sheet layers to reduce fouling and scaling on the packs to improve performance. The tubing or pipe acts as a distribution header to deliver chemicals or cleaning fluids through holes or nozzles to locations within the overall cooling tower fill section of the cooling tower. Additionally, the distribution header may be incorporated with a support, spacing, or grating system to space the header and individual lateral distribution legs and support the upper layers of fill to limit adverse impact on the tower's thermal performance or structural issues such as deformation of the fill in contact with the distribution system. This also allow for vertical space between packs to improve lateral distribution of chemical to flute openings within the fill packs.

Since it is known in the industry that occlusion from fouling occurs at fill interfaces, a support system that minimizes the number of pack-to-pack interface contact points is desirable to minimize biological growth due to bridging and to allow for improved flushing of solids from the fill from layer to layer. The grating or engineered piping and spacer configuration would have an opening larger than the fill flute openings at the pack-to-pack interface. This would improve the air flow fluid dynamics thereby redistributing the airflow locally within the bounds of the grating opening dimensions while allowing solids to be flushed from the fill normally caught by the interface edges and allowing for less directly injected chemical cleaner.

In a further aspect, the preferred invention is directed to a cleaning system for a mass transfer or cooling tower device having an enclosure, an air inlet and an air outlet in the enclosure, and first and second fill packs in the enclosure positioned between the air inlet and the air outlet. The first and second fill packs have peripheries that are positioned proximate to internal walls of the enclosure. The cleaning system includes an inlet connection mounted to the enclosure and a delivery piping system connected to the inlet connection. The delivery piping system is positioned within the enclosure between the first and second fill packs. The delivery piping system includes nozzles configured to direct a cleaning fluid onto the first and second fill packs.

In an additional aspect, the preferred invention is directed to a cleaning system for a mass transfer or cooling tower device having an enclosure, an air inlet and an air outlet in the enclosure, and a fill pack in the enclosure positioned between the air inlet and the air outlet. The fill pack has a periphery that is positioned proximate to internal walls of the enclosure. The cleaning system includes an inlet connection mounted to the enclosure and a delivery piping system connected to the inlet connection. The delivery piping system includes a cleaning portion positioned within the enclosure. The cleaning portion includes nozzles configured to direct a cleaning fluid onto the fill pack. A spacer member is mounted to the enclosure. The spacer member is in contact with and supports the cleaning portion above the fill pack. The spacer member includes piping cutouts to engage and support the cleaning portion.

### BRIEF DESCRIPTION OF THE SEVERAL VIEWS OF THE DRAWINGS

The foregoing summary, as well as the following detailed description of preferred embodiments of the system and method of the present application, will be better understood when read in conjunction with the appended drawings. For the purposes of illustrating the mass transfer device cleaning system, spacer and method of the preferred embodiments, there are shown in the drawings preferred embodiments. It should be understood, however, that the application is not limited to the precise arrangements and instrumentalities shown. In the drawings:

FIG. 1 illustrates a side elevational, cross-sectional view of a typical fill configuration in a counterflow cooling tower;

FIG. 2 illustrates a side elevational, cross-sectional view of placement of a connection and grating/spacer for a cleaning system for a counterflow cooling tower in accordance with a preferred embodiment of the present invention;

FIG. 3 illustrates a side elevational, cross-sectional view of a preferred embodiment of the cleaning system and spacer, wherein the cleaning system is arranged above a cooling tower fill;

FIG. 4 illustrates a top plan view of a series of chemical distribution and cleaning systems with grating of a preferred embodiment of the present invention;

FIG. 5 illustrates a top plan view of a series of chemical distribution and cleaning systems with spacers of a preferred embodiment of the present invention;

FIG. 6 illustrates a top plan view of a parallel chemical distribution and cleaning systems with grating in accordance with a preferred embodiment of the present invention;

FIG. 7 illustrates a top plan view of a parallel chemical distribution system with spacers in accordance with a preferred embodiment of the present invention,

FIG. 8 illustrates a side cross-sectional view of a spacer or grating member with cutouts for orienting chemical distribution piping and magnified views of a piping retention feature of the spacer or grating member taken from within the oval shapes of FIG. 8;

FIG. 9 illustrates a top plan view of a spacer in accordance with a first preferred embodiment of the present invention;

FIG. 9a illustrates a top plan view of a grating of the first preferred embodiment of the present invention;

FIGS. 10 and 10a illustrate side perspective views of distribution piping containing a single round hole in distribution piping for chemical distribution and a generally conical spray pattern for a single round hole for the purposes of chemical distribution;

FIGS. 11 and 11a illustrate side perspective views of the distribution piping containing a single slot for the purposes of chemical distribution and the distribution piping and spray pattern for a single slot for the purposes of chemical distribution;

FIG. 12 illustrates a side elevational view of a heat exchange device containing a flow prevention device and chemical cleaning system connection; and

FIG. 13 illustrates the placement of an installed cleaning system in a fluid cooler for a preferred embodiment of the present invention.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one.” The words “right”, “left”, “lower” and “upper” designate directions in the drawings to which reference is made. The words “inwardly” or “distally” and “outwardly” or “proximally” refer to directions toward and away from, respectively, the component parts or the geometric center of the preferred mass transfer device cleaning system and spacer and related parts thereof. The words, “anterior”, “posterior”, “superior,” “inferior”, “lateral” and related words and/or phrases designate preferred positions, directions and/or orientations in the human body to which reference is made and are not meant to be limiting. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

A preferred embodiment of the invention comprises a system, preferably a cleaning system for a mass transfer or cooling tower device 3, to introduce cleaning chemicals to a desired location in the cooling tower 3. Regulations require the periodic cleaning of cooling towers to stem the potential for biological proliferation. This cleaning requirement creates a maintenance cost for the cooling tower owners that has historically not been regulated. The purpose of the preferred invention is to reduce the financial burden on the cooling tower owner to maintain the safe operation of the cooling tower 3.

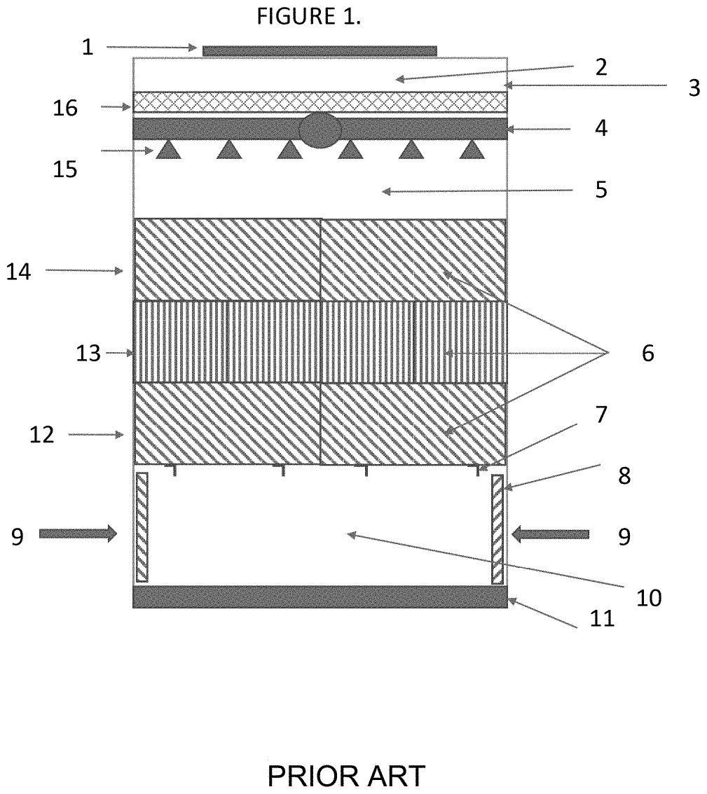

Referring to FIG. 1, a prior art counterflow cooling tower 3 removes waste heat from industrial processes by pumping hot water from a sump 11 to an open loop distribution piping 4 above the fill 6. Mass transfer occurs as the open loop water, which may also be comprised of another cooling fluid, flows from the open loop distribution system 4 via cooling tower or open loop nozzles 15 into a spray zone 5 where the water or other cooling fluid enters the fill 6. Water leaves the fill 6 entering the rain zone 10 where the water or cooling fluid collects in the sump 11. Air 9 is drawn through an air inlet 3i through louvers 8 into the rain zone 10 where it turns and enters the fill 6 at a bottom layer of the fill or a bottom fill pack 12. The air is drawn upward through the bottom layer 12, an intermediate fill pack 13 and top fill pack 14 or layer of the fill 6, through the spray zone 5, past the cooling tower nozzles 15 and open loop distribution system 4, through drift eliminators 16 into a plenum 2, through an air outlet 3o in the enclosure 3a and back to the atmosphere past a fan 1 installed at the top of the cooling tower. Supports 7 are positioned below the fill 6 to support the fill 6 within the cooling tower 3.

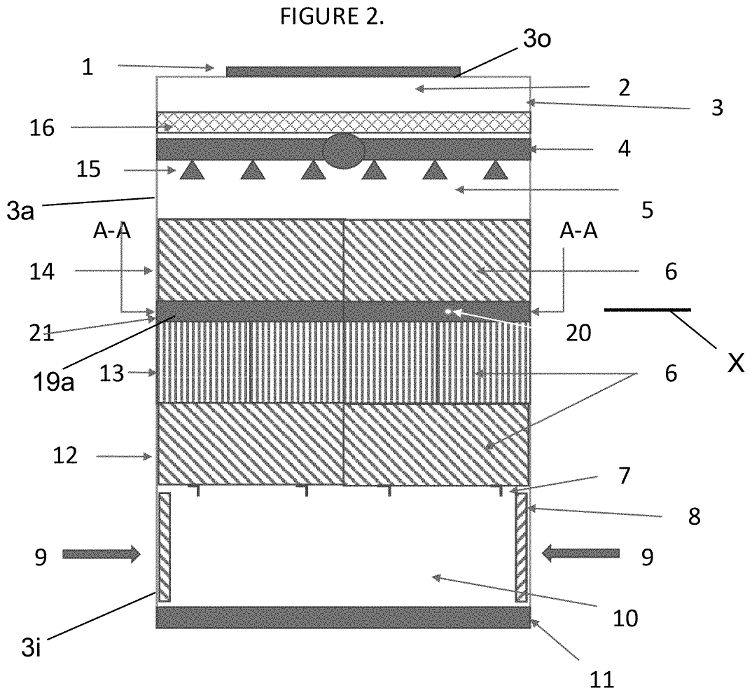

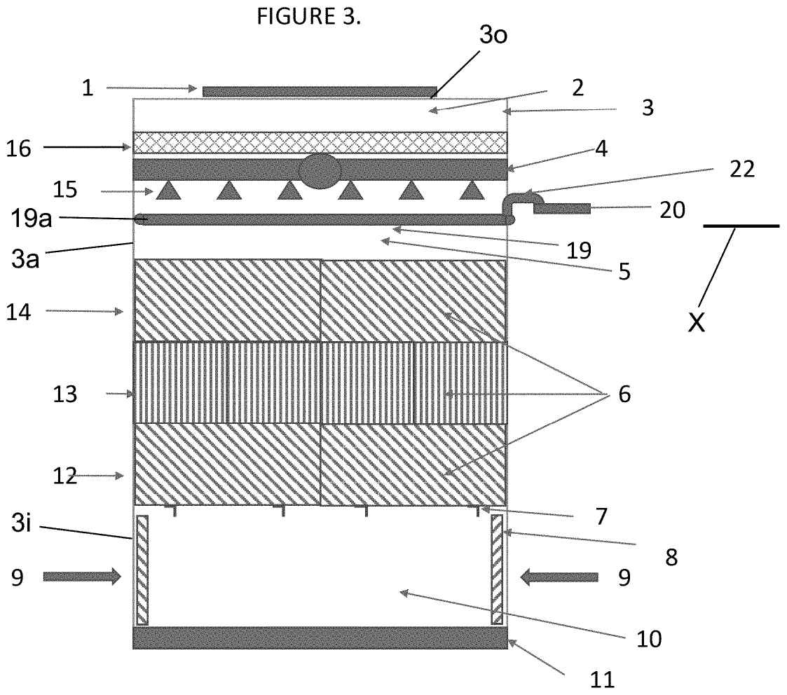

Referring to FIGS. 2 and 3, in a preferred embodiment an external cleaning connection 20 and chemical clean distribution piping 19 are configured and sized for the desired flow rate and discharge pressure to provide for sufficient cleaning chemicals to be delivered to the desired locations within the cooling tower 3. The external cleaning connection 20 is located for general access by the maintenance technician. If necessary, based on the location of the external inlet connection 20 or use of an installed pump and tank, the chemical clean distribution piping 19 penetrates the cooling tower at a location appropriate for minimal interference with the internal workings of the cooling tower 3. The location for penetration of the delivery piping system 19 is generally a location that minimizes the length of delivery piping system 19 or provides ease of access for maintenance. Since the cooling tower 3 may be operated year-round and may encounter freezing conditions, the inlet connection 20 and delivery piping system 19 are preferably fitted with a drain or other mechanism to maintain an empty pipe free of water and chemicals to avoid freezing of the water, chemicals and/or fluid within the delivery piping system 19 and connection 20. In the case where the inlet connection 20 is internal to the cooling tower 3, the inlet connection 20 and chemical clean distribution piping system 19 preferably still could be drained in the event of shutdown of the cooling tower 3, to prevent freezing of the delivery piping system 19 or for other reasons that would be apparent to one having ordinary skill in the art based on a review of the present application.

The first preferred embodiment of the invention is shown in a counterflow cooling tower arrangement where a grating or spacer 21 is placed between a first fill pack 14 or a top fill layer 14 and a second fill pack 13 or an intermediate fill layer 13. The inlet connection 20 is preferably located external to the cooling tower 3 on the cooling tower enclosure 3. The inlet connection 20 may be located at any point on an enclosure 3a of the cooling tower 3 that preferably provides easy access by maintenance technicians. A second embodiment of the preferred invention in FIG. 3 shows the chemical clean distribution piping or delivery piping system 19 located in the spray zone 5 below the cooling tower nozzles 15. The cleaning chemicals introduced at this location in the spray zone 5 in the cooling tower 3 are distributed above the top fill layer or first fill pack 14. The open space enables the free and open flow of cleaning chemicals from the chemical clean distribution piping or delivery piping system 19 and associated nozzles 15 to be directed to the desired locations within the cooling tower 3, preferably where fouling is anticipated in the fill layers or fill packs 14, 13, 12.

The preferred piping for the chemical clean distribution piping or delivery piping system 19 can be configured in any manner appropriate for providing cleaning chemicals to the cooling tower 3. In general, the delivery piping system 19 provides flow to at least one delivery exit point or nozzle 50 and preferably a plurality of nozzles 50. The nozzle 50 preferably is comprised of a hole or slot for simplicity to a specially designed nozzle such as those designed for chemical spraying of pesticides and herbicides for agriculture or other purposes. The nozzles 50 can introduce air to provide a foamed chemical, or not, to provide a simple chemical stream. The delivery piping system 19 may be configured in a series arrangement providing sequential flow to the series or plurality of nozzles 50 from one point-source. In a series configuration, the delivery piping system 19 could be arranged to travel in a serpentine pattern to provide distribution to desired cooling tower locations such that desired portions of the fill packs 14, 13, 12 are contacted by the cleaning chemicals. The delivery piping system 19 may be configured in a parallel arrangement where the delivery piping system 19 immediately downstream of the inlet connection 20 acts as a header 33 to provide flow to laterals or parallel piping 34 connected in a T-style fashion to the header 33. This arrangement reduces the head pressure required by the pump to provide flow and pressure to the nozzles 50 for adequate distribution but can increase piping cost based on the number of fittings required for this configuration. Alternatively, a piping loop may be connected to one chemical inlet connection. The loop may contain no, one, or multiple laterals, parallel piping or legs 34 connecting across the loop to provide more nozzles 50 for better distribution of the cleaning fluid onto the fill packs 14, 13, 12 or the enclosure 3a where fouling, biogrowth and/or scaling may accumulate.

The nozzles 50 can be placed to provide a specific spray pattern or designed to provide a foam that would self-distribute based on the viscous nature of the foam and the pressure drop associated with the cooling tower fill 14, 13, 12. In general, the delivery piping system 19, most preferably a cleaning portion 19a of the delivery piping system 19, is preferably placed below the first layer, top layer of fill or first fill pack 14 as this tends to be the area of greatest fouling, biogrowth and/or scaling, although the cleaning portion 19a may also be positioned between the second or intermediate fill pack 13 and the lower fill pack 12 or above the top layer of fill or first fill pack 14, as long as the cleaning material may be disbursed or sprayed onto the fill 6 to clean fouling, biogrowth, scaling or nearly any materials that are adhered to or positioned on the fill 6. A grating or spacer 41 may be utilized to support the upper layer(s), top layer of fill or first fill pack 14, which may also provide a gap between the fill layers or fill packs 14, 13, 12 for adequate spray pattern development for chemical distribution onto the fill 6. The grating or spacer 41 is not limited to supporting the fill packs 14, 13, 12 and may be mounted to the enclosure 3a at a location spaced from the fill 6 and for supporting the cleaning portion 19a to direct the cleaning fluid onto the fill 6. The grating or spacer 41 may also be used to position the delivery piping system 19 in the desired configuration for distribution of cleaning chemicals. The grating or spacer 41 is preferably designed with an open arrangement, that is, the pattern of vertical supports is such that the grating or spacer 41 allows for a reduced number of contact points with the edge of the fill packs 14, 13, 12 above and below the grating or spacer 41 and allows for communication across flute openings that extend through the fill 6 within its height limitation. Since it has been shown that fouling in cooling towers often occurs at interface points within the fill packs 14, 13, 12, therefore a reduction in the number of interfaces with the fill packs 14, 13, 12 will reduce the potential for bridging and fouling. The communication between flutes of the fill packs 14, 13, 12 in the space between adjacent fill packs 14, 13, 12 defined by the grating or spacer 41 allows for chemical distribution and redistribution of air flow based on head loss generated by fouling. The inclusion of the grating or spacer 41 provides the ability to maintain air flow rates through the fill packs 14, 13, 12 and therefore cooling tower thermal performance. The grating or spacer 41 may be used specifically in this manner to reduce fouling and maintain air flow performance of the cooling tower 3. The grating or spacer 41 is designed to provide adequate structural interface support to minimize deformation of edges of the fill packs 14, 13, 12 and associated fouling and pressure drop that is likely to result if edges of the fill packs 14, 13, 12 are deformed or damaged.

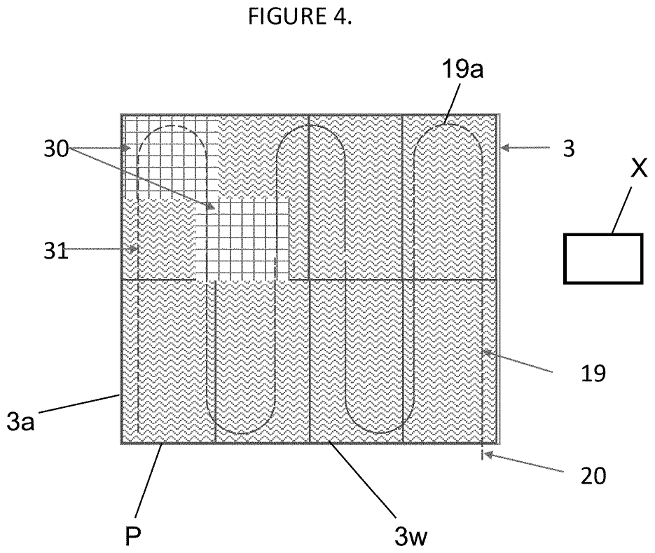

Referring to FIG. 4, the plan view of a series or the cleaning portion 19a of the delivery piping system 19 arrangement has a serpentine piping arrangement and is generally positioned on a horizontal plane X between the first or top fill pack 14 and the second or intermediate fill pack 13. The chemical clean distribution piping or the delivery piping system 19 in this preferred embodiment includes the inlet connection 20 that is positioned external to the enclosure 3a and the series or serpentine arrangement 31 of the cleaning portion 19a of the delivery piping system 19, although the cleaning portion 19a is not limited to a serpentine arrangement 31 and may have nearly any shape and orientation that is desired by the user or designer to direct the cleaning fluid at appropriate locations onto the fill packs 14, 13, 12. A tower grating 30 maintains the position of the preferred delivery piping system 19 in this preferred embodiment, although the grating 30 is not limiting and the delivery piping system 19 may be maintained in position by nearly any structural element that is able to position the delivery piping system 19 in the desired location, perform the preferred functions of the grating 30 and withstand the normal operating conditions of the grating 30.

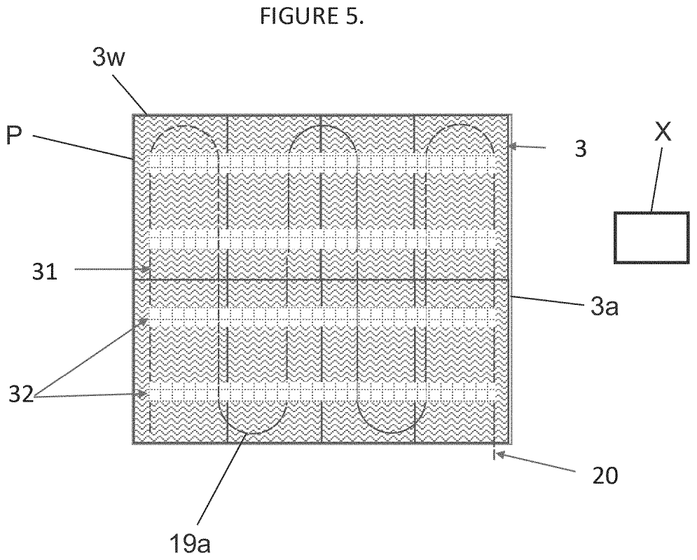

Referring to FIG. 5, a spacer 32, such as the spacer member 41, preferably maintains the position of the series or serpentine arrangement 31 of the delivery piping system 19. The grating 30 and spacer 32 preferably provide space between stacked fill packs 14, 13, 12 for distribution of cleaning chemicals as the spray pattern preferably develops unencumbered for distribution or in other words the spray pattern continues to develop until the cleaning fluid reaches an impediment, such as the fill packs 14, 13, 12 or the enclosure 3a.

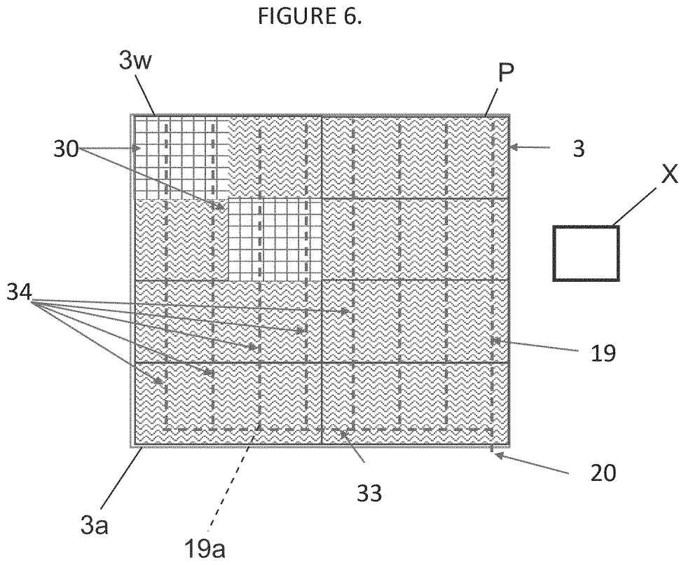

Referring to FIG. 6, a top plan view of a parallel piping or piping arrangement 34 of the delivery piping system 19 that is supplied from the header 33 is shown. The chemical clean distribution or delivery piping system 19 in this preferred embodiment includes the inlet connection 20 and generally parallel piping 34 in the cleaning portion 19a, although the arrangement is not so limited. The grating 30 preferably maintains the position of the parallel lines or parallel portions 34 of the cleaning portion 19a of the delivery piping system 19.

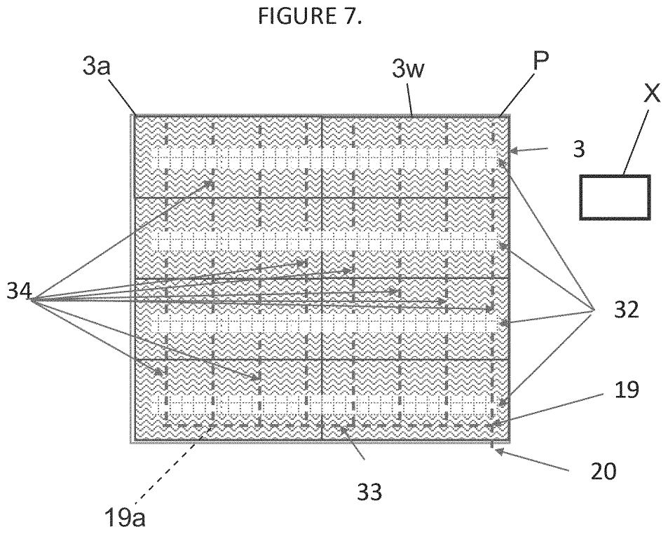

Referring to FIG. 7, a spacer 32, such as the spacer member 41, preferably maintains the position of the cleaning portion 19a of the parallel delivery piping system 19. The grating 30 and spacer 32 provide space between stacked fill packs 14, 13, 12 for distribution of cleaning chemicals as the spray pattern preferably develops unencumbered for distribution or in other words the spray pattern continues to develop until the cleaning fluid reaches an impediment, such as the fill packs 14, 13, 12 or the enclosure 3a.

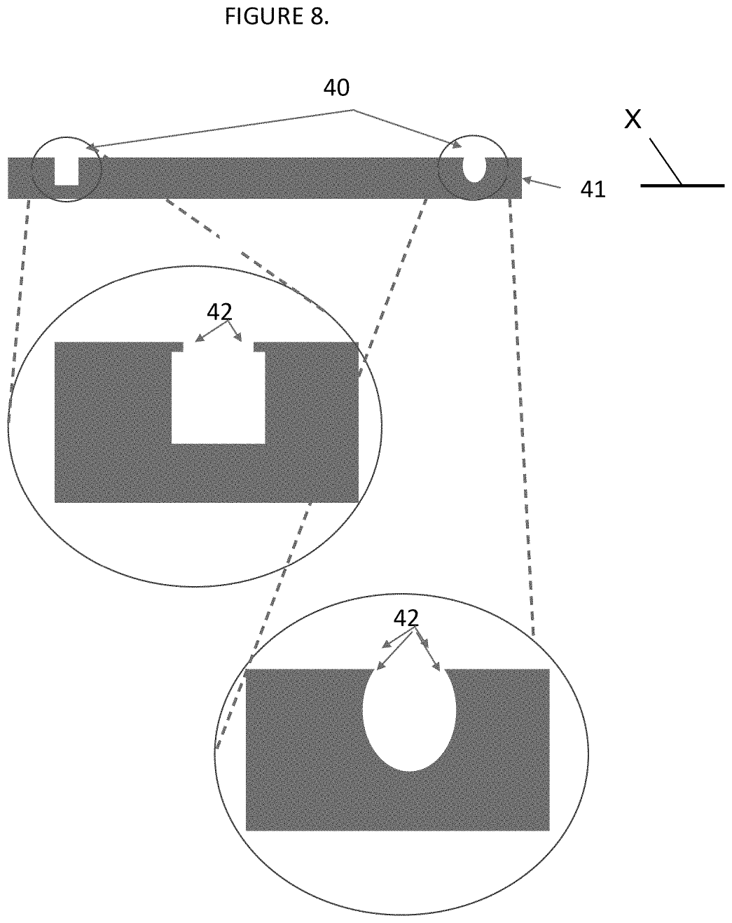

Referring to FIG. 8, a piping cutout or guide slot 40 may be located in a grating or spacer member 41 that serves to provide a space or guide for the cleaning portion 19a of the chemical clean distribution or delivery piping system 19. The piping cutout 40 may include piping capture tabs 42 to engage the piping of the cleaning portion 19a or to provide an interference fit with the cleaning portion 19a of the delivery piping system 19 to securely hold the cleaning portion 19a relative to the grating or spacer member 41, although the grating or spacer member 41 is not so limited and may include alternative engagement mechanisms, such as clips, fasteners, adhesive bonding or other securement mechanisms or techniques to hold the delivery piping system 19 and the cleaning portion 19a at a preferred location and/or orientation relative to the fill packs 14, 13, 12 and the enclosure 3a.

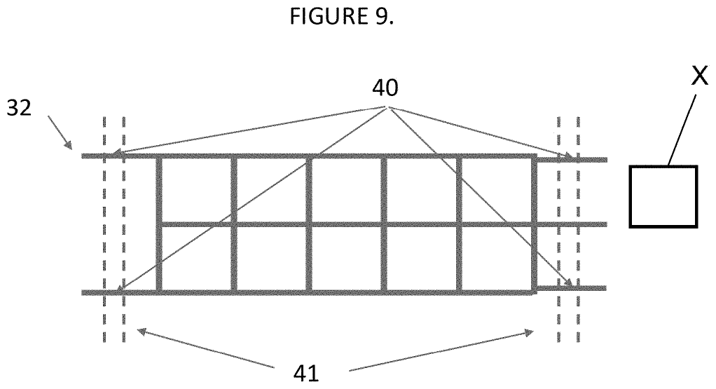

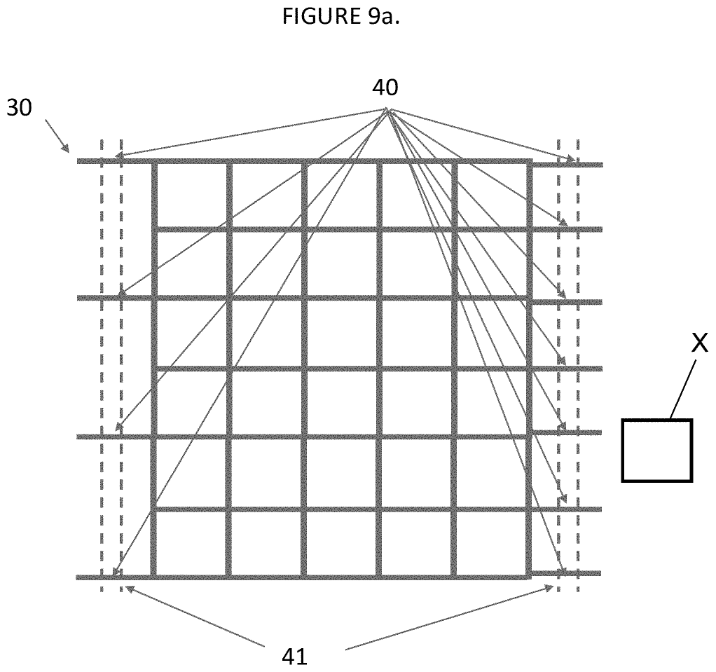

Referring to FIGS. 9 and 9a, plan views of the spacer 32 and grating 30, respectively, shows the piping cutout made in the top portion of the grating or spacer members 41 that are preferably slotted for the cleaning portion 19a and the chemical clean distribution or delivery piping system 19.

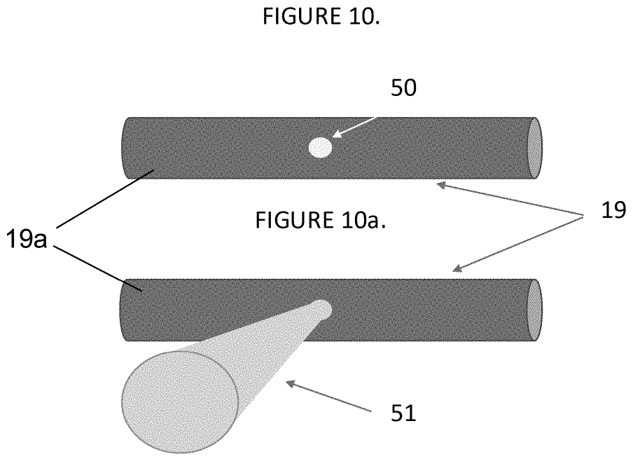

Referring to FIGS. 10 and 10a, a first preferred embodiment of the chemical clean distribution or delivery piping system 19 is shown containing a round hole nozzle 50 or nozzle configuration 50 and an associated conical spray pattern 51. The spray patter resulting from this generally circular nozzle 50 results in a generally conical-shaped spray pattern for directing the cleaning fluid onto the fill packs 14, 13, 12 and enclosure 3a.

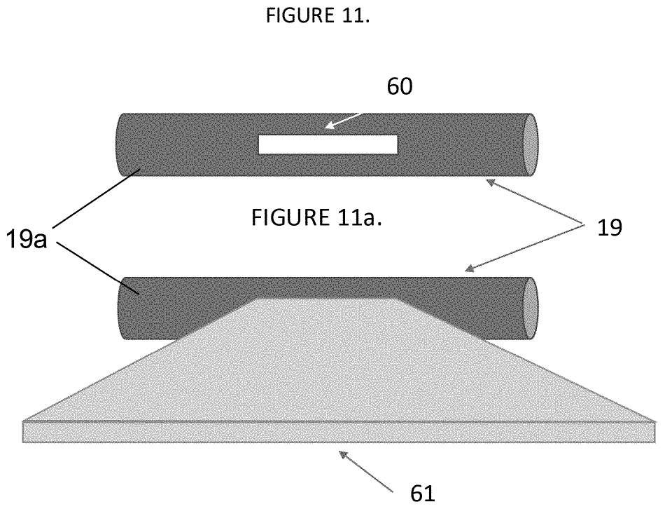

Referring to FIGS. 11 and 11a, a second preferred embodiment of the chemical clean distribution or delivery piping system 19, preferably in the cleaning portion 19a, is shown containing a slotted hole nozzle configuration 60 and associated fan-shaped spray pattern 61. The slotted hole nozzle 60 in this second preferred embodiment is generally rectangular and results in a fan-shaped spray pattern with a generally rectangular cross-section. The preferred piping 19 is not limited to including only the first preferred round hole nozzle configuration 50 and the second preferred slotted hole nozzle configuration 60 and may have nearly any nozzle configuration integrated into the delivery piping system 19 or may include specialty or separate nozzles (not shown) that connect to the delivery piping system 19. The nozzle configuration 50, 60 is preferably designed and configured to direct the cleaning spray or fluid onto the fill packs 14, 13, 12 or other portions of the tower where fouling, biogrowth and/or scaling may occur on the cooling tower 3 or fill packs 14, 13, 12.

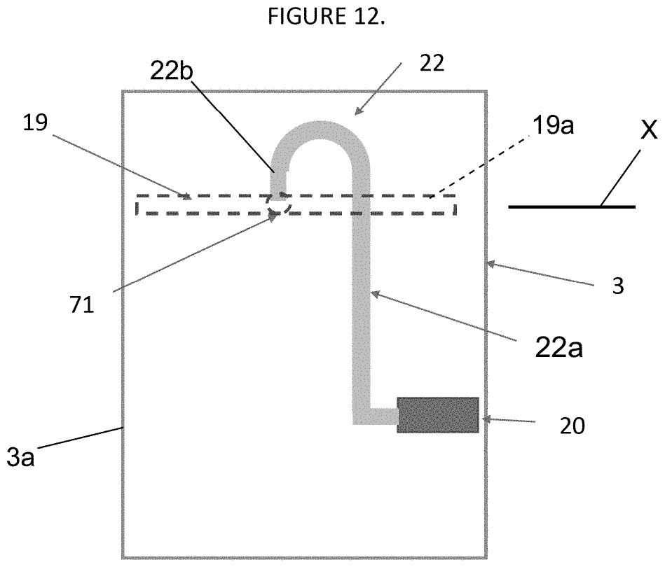

Referring to FIG. 12, a backflow preventer 22 may be incorporated into the delivery piping system 19 and is preferably installed between the external cleaning system connection or the inlet connection 20. The backflow preventer 22 preferably serves to prevent the leakage of recirculating water from the cooling tower 3 and drains the external cleaning system connection or the inlet connection 20 and chemical clean distribution or delivery piping system 19 to prevent damage from freezing in cold environments. A drain hole is preferably placed in the chemical clean distribution or delivery piping system 19 internal to the cooling tower 3 to drain the delivery piping system 19 after a cleaning cycle and upon cooling tower shutdown. The preferred system is not limited to including the backflow preventer 22 and the system may operate and function without the backflow preventer 22 without significantly impacting the function and operation of the system.

The cleaning system preferably includes a connection capable of being attached to the discharge side of a chemical pump. The discharge side of the chemical pump is preferably connected to the inlet connection 20. The inlet connection 20 can be a quick disconnect type or include threading of pipe fittings in place to provide a path for the flow of cleaning chemicals to the delivery piping system 19. The inlet connection 20 preferably enables the maintenance technician to attach a chemical pump to draw cleaning chemicals from a portable container and into the delivery piping system 19 for distribution or spraying onto the fill packs 14, 13, 12 or other portions of the cooling tower 3 that the user or designer desires to clean with the cleaning fluid.

The pump preferably provides adequate pressure and flow of chemicals to the installed cleaning system to clean the fill packs 14, 13, 12 or other portions of the cooling tower 3. The use of a portable pump is typically not required, that is, a permanent pump, chemical tank, or system with diagnostic monitoring capabilities may be installed; however, for most installations a portable pump and tank would reduce the cost of the installed cleaning system for each cooling tower 3 while still providing for the ability for cleaning. The preferred system is, therefore, adaptable for use with a portable pump and/or a permanent pump for driving the cleaning fluid through the delivery piping system 19.

Referring to FIGS. 2 and 4-12, the cleaning system for the mass transfer or cooling tower 3 having the enclosure 3a is designed for cleaning the airflow portions of the cooling tower 3. The cooling tower 3 includes the air inlet 3i and the air outlet 3o in the enclosure 3a, and first and second fill packs 14, 13 positioned in the enclosure 3a between the air inlet 3i and the air outlet 3o. The first and second fill packs 14, 13 have peripheries P or a periphery P that are positioned proximate internal walls 3w of the enclosure 3a (See FIGS. 4-7). The peripheries P of the fill packs 14, 13, 12 are preferably positioned proximate the internal walls 3w so that all of the air flowing through the cooling tower 3 flows through the fill packs 14, 13, 12, preferably through the flutes of the fill packs 14, 13, 12, as opposed to portions of the air flowing around the fill packs 14, 13, 12 between the peripheries P and the internal walls 3w. The peripheries P preferably extend fully around the fill packs 14, 13, 12 and are positioned proximate the internal walls 3w of the enclosure 3a.

The inlet connection 20 is mounted to the enclosure 3a of the cooling tower 3 such that a technician can gain access to the inlet connection 20 from outside the enclosure 3a. The inlet connection may be comprised of a quick disconnect fitting such that the technician can quickly and easily connect to a source of cleaning fluid for introduction to the cleaning system. The inlet connection 20 may also be comprised of a threaded connection, a permanent connection or nearly any connection that facilitates introduction of the cleaning fluid into the delivery piping system 19.

The delivery piping system 19 is connected to the inlet connection 20 and includes the cleaning portion 19a that is positioned within the enclosure 3a between the first and second fill packs 14, 13 in the first preferred embodiment. The cleaning portion 19a may have many configurations and orientations to direct the cleaning fluid onto desired locations on the fill packs 14, 13, 12, such as the serpentine arrangement 31 that is comprised of a serpentine tubing portion that is positioned on the horizontal plane X between the first and second fill packs 14, 13 in the first preferred embodiment, the plurality of parallel piping portions or parallel arrangement 34 of the second preferred embodiment that is positioned on the horizontal plane X between the first and second fill packs 14, 13 or may be otherwise arranged based on designer preferences or the particular arrangement of the cooling tower 3 to focus the cleaning fluid on areas where fouling, biogrowth and/or scaling may accumulate. The cleaning portion 19a may alternatively be positioned above the first fill pack 14, below the bottom fill pack 12, between the second fill pack 13 and the bottom fill pack 12 or may be otherwise arranged to direct the cleaning fluid onto the fill 6 at desired locations.

The delivery piping system 19 and, particularly, the cleaning portion 19a includes nozzles 50, 60 that are configured to direct cleaning fluid onto the fill packs 14, 13, 12 and the enclosure 3a where fouling, biogrowth and/or scaling may accumulate. The nozzles 50 may take on the configuration of the relatively round holes in the delivery piping system 19, wherein each of the plurality of nozzles 50 is configured to produce the conical spray pattern of cleaning fluid during use. The nozzles 60 may alternatively take on the configuration of the relatively rectangular slots in the delivery piping system 19, wherein each of the plurality of nozzles 60 is configured to produce the fan-shaped spray pattern of the cleaning fluid during use having the generally rectangular cross-section. The nozzles 50, 60 may also be configured to introduce air with the cleaning fluid to provide a foamed chemical onto the fill packs 14, 13, 12, during use.

The preferred cleaning system includes the backflow preventer 22 comprised of an upwardly extending pipe portion 22a extending from the inlet connection 20 and a downwardly extending pipe portion 22b extending from the upwardly extending pipe portion 22a to the cleaning portion 19a. the backflow preventer 22 generally prevents significant backflow of the cleaning fluid from the cleaning portion 19a to the inlet connection 20. The cleaning portion 19a or nearly any portion of the delivery piping system 19 that is at a relatively low portion of the delivery piping system 19 may be connected to an enclosure penetration 71 that may be plugged during normal use and opened to bleed the delivery piping system 19 for maintenance or when the cleaning system is not being used.

The preferred cleaning system may also include the spacer member 41 that is mounted to the enclosure 3a. The spacer member 41 is configured to support and align the cleaning portion 19a and the delivery piping system 19 relative to the first and second fill packs 14, 13, the fill 6 and the enclosure 3a. The spacer member 41 is preferably comprised of a grating or structural spacer that is relatively rigid, can withstand the normal operating conditions of the cooling tower 3 and perform the functions of the spacer member 41, as described herein. The spacer member 41 may include the guide slot 40 that engages the cleaning portion 19a or portions of the cleaning portion 19a or the delivery piping system 19 in a mounted configuration. The guide slots 40 are configured to support the delivery piping system 19 in the enclosure 3a and structurally support the cleaning portion 19a and the delivery piping system 19 to direct the cleaning fluid spray onto the fill 6 and the enclosure 3a. In the first preferred embodiment, the first fill pack 14 is in contact with and supported by the spacer member 41 in the mounted configuration. The guide slots 40 may positively engage the delivery piping system 19 or may generally position and support the delivery piping system 19 without positively engaging the delivery piping system 19. For positive engagement, the guide slots 40 may include the piping capture tabs 42 that secure the cleaning portion 19a to the spacer member 41 in the mounted configuration.

Referring to FIGS. 3-12, the cleaning system for the mass transfer or cooling tower 3 having the enclosure 3a includes the spacer member 41 mounted to the enclosure 3a above the fill packs 14, 13, 12. The spacer member 41 includes the guide slots or piping cutouts 40 that engage and support the cleaning portion 19a of the delivery piping system 19. In use, the nozzles 50, 60 of the cleaning portion 19a sprays the cleaning fluid onto the top or first fill pack 14 and the cleaning fluid flows under the force of gravity onto the lower second, intermediate and/or lower fill packs 13, 12 to clean the surfaces of these fill 6.

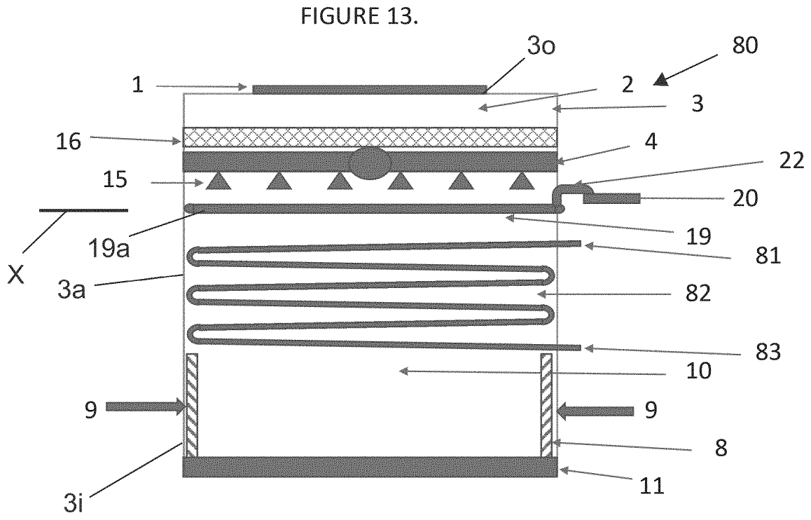

Referring to FIG. 13, the cleaning system may also be incorporated into a fluid cooler 80, which has a similar configuration to the cooling tower 3 without the fill 6. The fluid cooler 80 includes a heat exchange coil 82 positioned within the enclosure 3a that carries hot fluid from a hot water inlet 81 to a cold water outlet 83. The fluid in the heat exchange coil 82 is cooled as it flows through the heat exchange coil 82 by the cooling fluid from the open loop nozzles 15. The nozzles 50, 60 of the cleaning portion 19a of the delivery piping system 19 direct the cleaning fluid onto the heat exchange coil 82 to clean fouling, biogrowth and/or scaling that may accumulate on surfaces of the heat exchange coil 82 during operation of the fluid cooler 80.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

I/We claim:

1. A cleaning system for a mass transfer or cooling tower device having an enclosure, an air inlet and an air outlet in the enclosure, and first and second fill packs in the enclosure positioned between the air inlet and the air outlet, the first and second fill packs having peripheries that are positioned proximate to internal walls of the enclosure, the cleaning system comprising:
an inlet connection mounted to the enclosure; and
a delivery piping system connected to the inlet connection, the delivery piping system including a cleaning portion being positioned within the enclosure between the first and second fill packs, the cleaning portion including nozzles configured to direct a cleaning fluid onto the first and second fill packs.

2. The cleaning system of claim 1, further comprising:
a spacer member mounted to the enclosure, the spacer member configured to support and align the cleaning portion relative to the first and second fill packs.

3. The cleaning system of claim 2, wherein the spacer member is comprised of a grating or a structural spacer.

4. The cleaning system of claim 2, wherein the spacer member includes a guide slot, the cleaning portion engaged by the guide slot in a mounted configuration.

5. The cleaning system of claim 2, wherein the first fill pack is in contact with and supported by the spacer member in a mounted configuration.

6. The cleaning system of claim 4, wherein the guide slot includes piping capture tabs, the piping capture tabs securing the cleaning portion to the spacer member in the mounted configuration.

7. The cleaning system of claim 1, wherein the nozzles are comprised of a plurality of relatively round holes in the delivery piping system, each of the plurality of holes configured to produce a conical spray pattern of the cleaning fluid during use.

8. The cleaning system of claim 1, wherein the nozzles are comprised of a plurality of generally rectangular slots in the delivery piping system, each of the plurality of slots configured to produce a fan-shaped spray pattern of the cleaning fluid during use having a generally rectangular cross-section.

9. The cleaning system of claim 1, wherein the inlet connection is comprised of a quick disconnect fitting.

10. The cleaning system of claim 1, wherein the delivery piping system includes a backflow preventer comprised of an upwardly extending pipe portion extending from the inlet connection and a downwardly extending pipe portion extending from the upwardly extending pipe portion to the cleaning portion.

11. The cleaning system of claim 1, wherein the cleaning portion includes a serpentine tubing portion, the serpentine tubing portion positioned on a generally horizontal plane between the first and second fill packs.

12. The cleaning system of claim 1, wherein the cleaning portion includes a plurality of parallel piping portions, the plurality of parallel piping portions positioned on a generally horizontal plane between the first and second fill packs.

13. The cleaning system of claim 1, wherein the nozzles are configured to introduce air with the cleaning fluid to provide a foamed chemical onto the fill packs during use.

14. A cleaning system for a mass transfer or cooling tower device having an enclosure, an air inlet and an air outlet in the enclosure, and a fill pack in the enclosure positioned between the air inlet and the air outlet, the fill pack having a periphery that is positioned proximate to internal walls of the enclosure, the cleaning system comprising:
an inlet connection mounted to the enclosure;
a delivery piping system connected to the inlet connection, the delivery piping system including a cleaning portion positioned within the enclosure, the cleaning portion including nozzles configured to direct a cleaning fluid onto the fill pack; and
a spacer member mounted to the enclosure, the spacer member in contact with and supporting the cleaning portion above the fill pack, the spacer member including piping cutouts to engage and support the cleaning portion.

15. The cleaning system of claim 14, wherein the spacer member is comprised of grating.

16. The cleaning system of claim 14, wherein the nozzles are comprised of relatively round holes in the cleaning portion.

17. The cleaning system of claim 14, wherein the nozzles are connected to the cleaning portion.

18. The cleaning system of claim 14, wherein the cleaning portion includes a plurality of parallel piping portions.

19. The cleaning system of claim 14, wherein the cleaning portion includes a serpentine tubing portion, the serpentine tubing portion positioned on a generally horizontal plane.

20. The cleaning system of claim 14, wherein portions of the cleaning portion are positioned within the piping cutouts in a mounted configuration.
